(19) United States
(12) Patent Application Publication
(10) Pub. No.: US 2015/0138616 A1
(43) Pub. Date: May 21, 2015

(54) LASER SCANNER APPARATUS

(71) Applicant: Hoyt N. Burns, Orlando, FL (US)

(72) Inventor: Hoyt N. Burns, Orlando, FL (US)

(73) Assignee: H.N. BURNS ENGINEERING CORPORATION, Orlando, FL (US)

(21) Appl. No.: 14/082,861

(22) Filed: Nov. 18, 2013

(51) Int. Cl. G02B 26/10

(52) U.S. Cl. CPC G02B 26/105
USPC 359/213.1

(57) ABSTRACT

The present invention relates to a reactionless, constant scanning velocity laser scanner having a scanning mirror and a counter-rotating mass trading kinetic energy as the mirror collides with the counter rotating mass rotating in opposite direction to reverse the direction of rotation of the mirror. The scanning mirror is rotatably mounted in a frame and spaced from a rotatably mounted counterweight such that in each direction of rotation the mirror will collide with the counterweight moving in the opposite direction of rotation. The counterweight has spring means thereon positioned to bump against the mirror in one direction and then the other direction of rotation to repel the mirror to cause a back and forth scanning motion in the mirror. The counterweight is moved by an actuator which replaces energy lost during scanning.

### FIELD OF THE INVENTION

This invention relates to a laser scanner and especially to a laser scanner having a scanning mirror driven by a spaced counter rotating mass colliding with the mirror in each direction of rotation trading kinetic energy therebetween.

### BACKGROUND OF THE INVENTION

A laser scanner is a light beam deflector used to control the deflection of a laser beam. Most laser scanners use moveable mirrors to steer a laser beam. Rotating mirror scanners use a rapid rotation of a polygonal mirror around an axis while a galvanometer scanner uses a galvanometer to move the mirror in a predetermined scan. The present invention is for a mechanically oscillating reflective mirror with a constant velocity. To control scanning motion, scanners use a rotary encoder and control electronics to drive the scanner actuators.

The Culp U.S. Pat. No. 5,066,084 is for a constant velocity optical scanner which uses a reflecting mirror rotatably mounted in a frame which frame has piezoelectric actuators mounted thereon on both sides of the mirror for moving the mirror in a scanning motion. The mirror frame has contact springs or bumpers thereon to provide a contact between the scanning mirror and the frame actuators. The magnitude of energy required to return the mirror after contact between the mirror pads and the actuators is calculated to minimize the energy needed to operate the scanner.

The Ostaszewski U.S. Pat. No. 5,283,682, is for a thermal infrared radiometer scanning system which has a movable mirror, a reaction mass and an associated mirror position sensing system. A rotatable yoke has the movable mirror rotatably mounted thereon and has a reaction mass also rotatably mounted to the yoke. The yoke is rotated by a motor. The rotatably mounted mirror is connected to the rotatably mounted reaction mass with two flexible springs in a manner that when the reaction mass is moved on an arc on its axis of rotation in one direction it pulls the rotatably mounted mirror in an arc on its axis of rotation in the same direction bending one of the springs in each direction. The reaction mass is moved back and forth by actuators on the yoke positioned at each end of the mass.

A series of related U.S. Pat. Nos. 7,042,613 and 7,177,063 and 7,332,367 and Patent Application Publication No. US2005/0036196, all assigned to Terraop, Ltd. each teach a MEMS apparatus for scanning an optical beam having a mirror operative to perform a rotational motion to a maximum rotation angle around a mirror rotation axis and a bouncing mechanism operative to provide a bouncing event to reverse the rotational motion of the mirror.

Other prior art U.S. patents include the Ostaszewski U.S. Pat. No. 5,277,076 for a reactionless scan mechanism and the Roth U.S. Pat. No. 4,439,003 for a remote counter-balancing mechanism.

The present laser scanner is for a mechanically oscillating reflective mirror scanner having a constant velocity oscillating scanning mirror and a spaced oscillating counterweight having a spring or biasing means on each side thereof. The oscillating counterweight is actuated by actuators, such as a voice coil, which moves the counterweight in the opposite rotational direction of the rotating mirror until one edge of the mirror is impinged upon one of the springs of the counterweight to thereby reverse the rotational direction of both the mirror and counterweight. This produces the oscillating or rocking motion of both the mirror and counterweight in opposite directions of rotation until the impact between the two causes the reversal of the rotational direction of both.

### SUMMARY OF THE INVENTION

This invention relates to a laser scanner having a mechanically oscillating reflective scanning mirror having a constant scanning velocity driven by a spaced counter oscillating counterweight, spaced to cause a collision between the scanning mirror and the counterweight in each direction of rotation. The laser scanner has a scanner frame and a scanning mirror rotatably mounted therein and a counterweight also rotatably mounted in the scanner frame. The rotatably mounted scanning mirror and counterweight are mounted in a predetermined spaced relationship to each other and aligned to collide with each other in each direction of rotation to repel and reverse the direction of rotation of both the scanning mirror and the counterweight with each collision therebetween while trading kinetic energy therebetween. An actuator, such as a voice coil or motor, moves the counterweight in a back and forth rotation for collision with the scanning mirror so that a laser scanner scanning mirror scanning motion is produced by an oscillating counterweight. The counterweight has a pair of bumpers or springs thereon for repelling the scanning mirror with each collision with the counterweight. The springs may be coil springs and may be adjustable to vary the angle of the scanning mirror. Position encoders are coupled to both the mirror and counterweight. The counterweight and the scanning mirror may each be rotatably mounted in a separate frame portion which frame portions are attached together to position and align the scanning mirror relative to the counterweight.

### BRIEF DESCRIPTION OF THE DRAWINGS

The accompanying drawings, which are included to provide further understanding of the invention are incorporated in and constitute a part of the specification, and illustrate an embodiment of the invention and together with the description serve to explain the principles of the invention.

In the drawings:

FIG. 1 is a an exploded perspective view of a laser scanner in accordance with the present invention;

FIG. 2 is a perspective view of the scanning mirror rotatably mounted in the scanner frame of the scanner of FIG. 1;

FIG. 3 is a perspective view of the counterweight rotatably mounted in the scanner frame of the scanner of FIG. 1;

FIG. 4 is a sectional view taken through the laser scanner of FIG. 1 through 3 showing the mirror and counterweight in contact with each other;

FIG. 5 is an exploded view of the scanning mirror and mirror frame portion; and

FIG. 6 is a an exploded view of the counterweight and counterweight frame portion.

### DETAILED DESCRIPTION OF EXEMPLARY EMBODIMENT

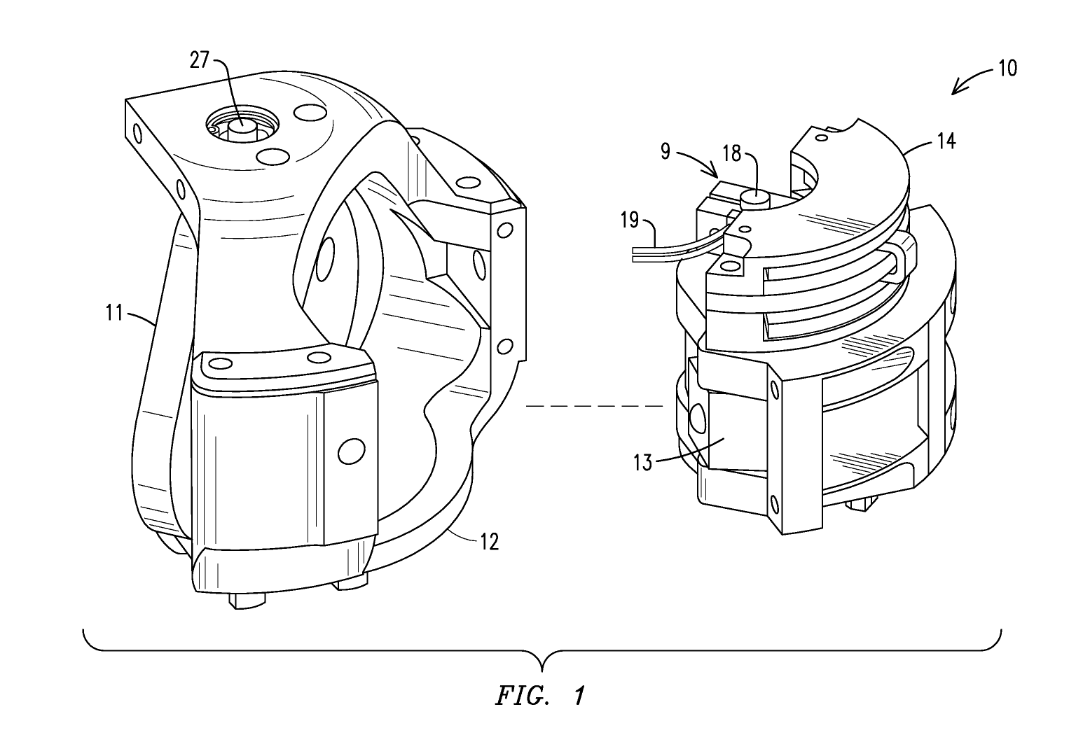

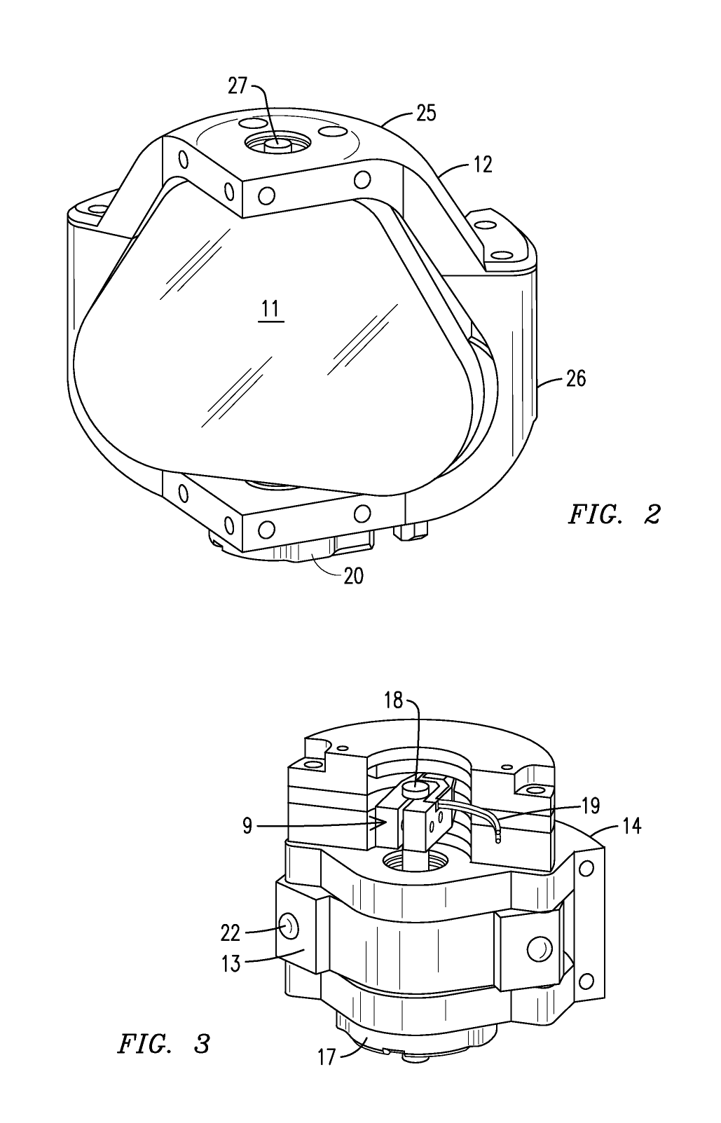

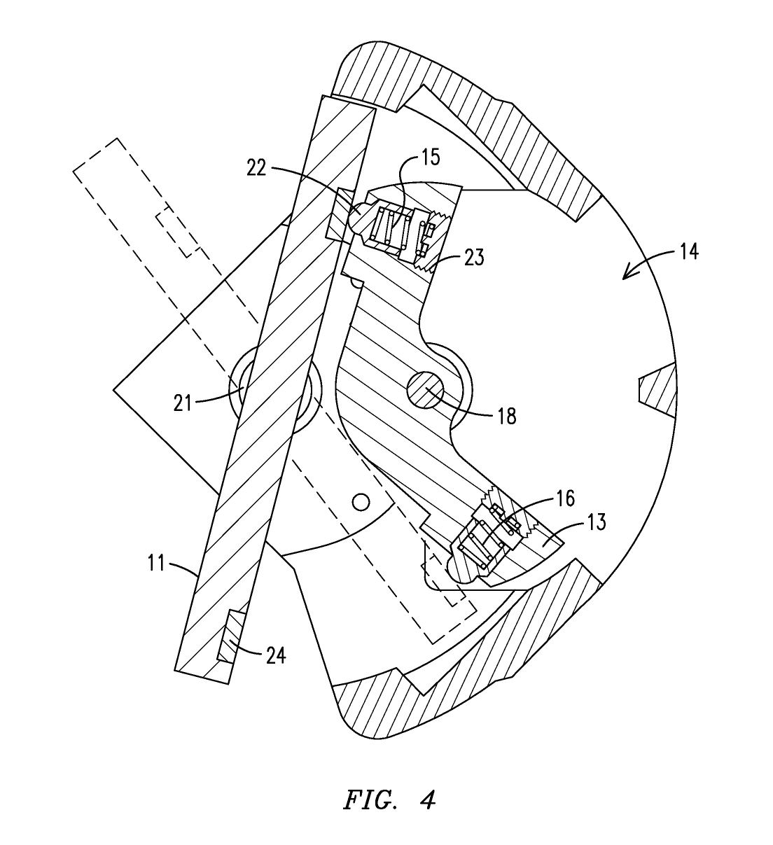

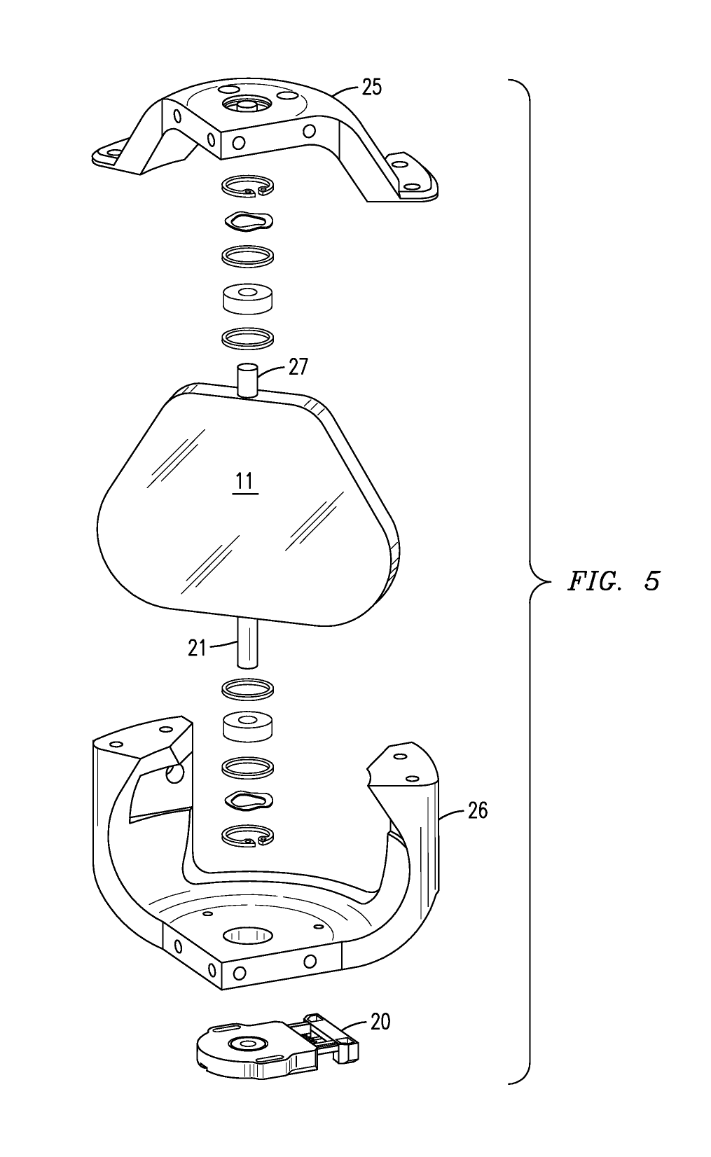

The present laser scanner 10 has a mechanically oscillating reflective scanning mirror 11 which has a constant scanning velocity and a counter rotating mass or counterweight 13. As seen in the drawings, FIGS. 1 through 6, the laser scanner 10 has the scanning mirror 11 rotatably mounted in a mirror frame 12. The counterweight 13 is rotatably mounted in a counterweight frame 14. As seen from the exploded view in FIG. 1, the mirror frame 12 and the counterweight frame 14 are attached together to form the laser scanner frame mounting the scanning mirror 11 and counterweight 13 in a predetermined spaced relationship aligning each to the other for collisions therebetween. This allows the scanning mirror 11 and the counterweight 13 to bump and repel each other when rotating in opposite directions. The counterweight 13 has a pair of springs 15 and 16 as seen in FIG. 4 which repels the scanning mirror with each collision to force a change in direction. The springs are illustrated as coil springs but may be any biasing means such as opposite polarity magnets or piezoelectric actuators or any spring or repelling force to stop and repel the scanning mirror 11 with each collision with the oppositely rotating counterweight 13 to cushion and transfer kinetic energy between the counterweight and the mirror.

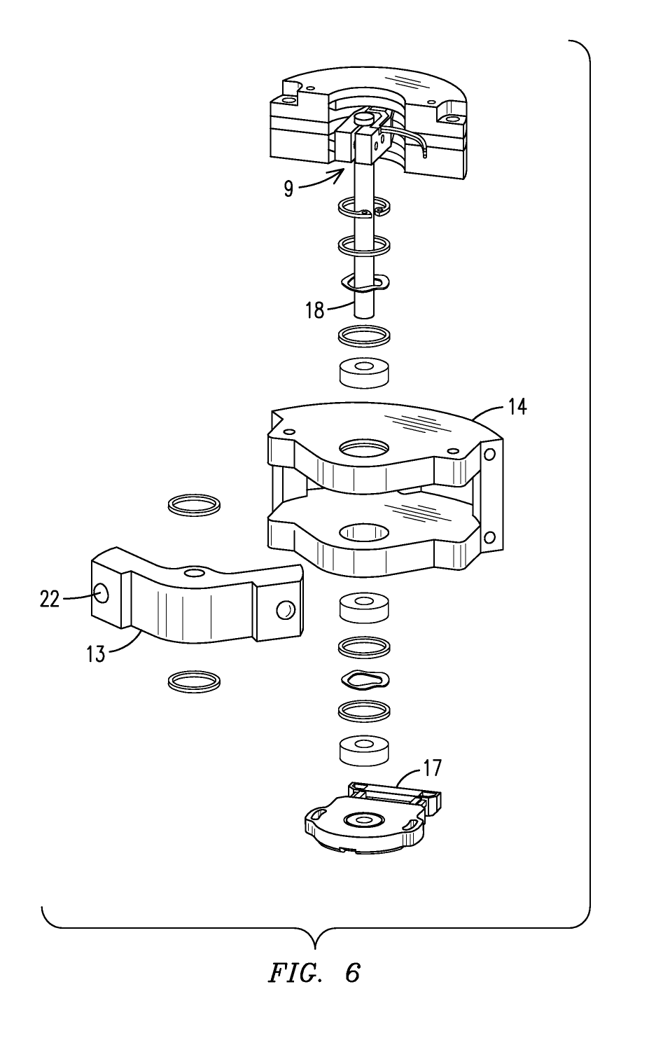

The counterweight assembly has a voice coil actuator 9 powered from a battery or other electric source connected through wires 19. The voice coil drives the counterweight 13 in both directions of rotation to cause a collision with the scanning mirror 11 in each direction of rotation. Any other means of driving the counterweight, such as an electric motor, can be used without departing from the spirit and scope of the invention. The counterweight has a position encoder 17 attached to the counterweight housing 14 to sense the position of the counterweight and to the counterweight shaft 18 while the scanning mirror has a position encoder 20 attached to the scanning mirror housing 12 and mirror shaft 21 to sense the position of the scanning mirror as seen in FIGS. 5 and 6.

The counterweight 13 has the springs 15 and 16 mounted therein and covered by a bumping surface 22 covering each spring. Each spring is held in place by a threaded fastener 23 which allows the spring force to be adjusted and vary the angle of scanning if desired. The scanning mirror may have a bumping surface 24 thereon aligned to impinge against the bumper 22 of the counterweight 13.

As seen in FIG. 5, the scanning mirror 11 frame or housing 12 may have an upper housing 25 and a lower housing 26 which are attached together such as by being bolted together. The mirror 11 has a lower shaft 21 which rotates in the lower housing 26 and an upper shaft 27 which rotates in upper housing 25. The shafts are mounted in bearings and have means to rotatably hold the shafts in the housings 25 and 26. The counterweight 13 is attached to the rotatable shaft 18 to rotate in the housing 14 as seen in FIG. 6. The shaft 18 is attached to the voice coil actuator 15 and to the position encoder 17 and rides in bearings and has means to rotatably hold the shaft 18 in place.

Referring to FIG. 4, the operation of the laser scanner 10 is illustrated with the counterweight 13 spring 15 bumper colliding with the scanning mirror 11. The scanning mirror 11 is then repelled by the collision and by the spring 15 in the opposite direction of rotation while the counterweight 13 is repelled in the opposite direction of rotation. The scanning mirror 11 and counterweight 13 then collide as seen in the phantom view with the spring 16, cushioning and repelling both the scanning mirror and counterweight back in the opposite direction of rotation. Thus the scanning mirror 11 scans through an angle with each rotation back and forth in a scanning or rocking motion. This forms a reactionless, constant scanning velocity scanning motion by the mirror and counter rotating mass trading kinetic energy therebetween with the voice coil actuator 19 replacing energy lost from friction and air losses in the mirror 11 and counterweight 13.

It should be clear at this time that a reactionless, constant scanning velocity laser scanner has been provided which uses a scanning mirror and a counter rotating mass trading kinetic energy as each collides with the other to reverse the direction of rotation of both. However the present invention is not to be considered limited to the forms shown which are to be considered illustrative rather than restrictive.

We claim:

1. A laser scanner apparatus comprising:
a scanner frame;
a scanning mirror rotatably mounted in said scanner frame;
a counterweight rotatably mounted in said scanner frame in a predetermined spaced relationship to said rotatable scanning mirror, and aligned to collide with said scanning mirror in each direction of rotation of said counterweight and scanning mirror to repel and reverse the direction of rotation of said scanning mirror with each collision; and
an actuator for moving said counterweight in a back and forth rotation for collision with said scanning mirror;
whereby a laser scanner scanning mirror scanning motion is produced by an oscillating counterweight in each direction of rotation thereof.

2. The laser scanner apparatus in accordance with claim 1 in which said counterweight has two end portions and has a bumper mounted on each of said two end portions for repelling said scanning mirror with each collision of said counterweight with said scanning mirror.

3. The laser scanner apparatus in accordance with claim 2 in which each said counterweight bumper includes a spring.

4. The laser scanner apparatus in accordance with claim 3 in which each said counterweight spring is a coil spring.

5. The laser scanner apparatus in accordance with claim 4 in which each said coil spring has a bumper cover thereover.

6. The laser scanner apparatus in accordance with claim 2 in which each said actuator is a voice coil actuator.

7. The laser scanner apparatus in accordance with claim 6 including a position encoder operatively coupled to read the position of said counterweight.

8. The laser scanner apparatus in accordance with claim 7 including a position encoder operatively coupled to read the position of said scanning mirror.

9. The laser scanner apparatus in accordance with claim 2 in which said frame has a counterweight frame rotatably supporting said counterweight attached to a scanning mirror frame rotatably supporting said scanning mirror.

10. The laser scanner apparatus in accordance with claim 2 in which said scanning mirror has a bumper positioned for contact with each said spring during each collision between said scanning mirror and said counterweight.

11. The laser scanner apparatus in accordance with claim 10 in which said laser scanner includes means for varying the scanning angle of said scanning mirror.

12. The laser scanner apparatus in accordance with claim 11 in which said means for varying the scanning angle of said scanning mirror includes said counterweight having an adjustment for each said spring.

13. The laser scanner apparatus in accordance with claim 1 having two actuators.

14. A laser scanner apparatus comprising:
a scanner frame having a scanning mirror portion and a counterweight portion;
a scanning mirror rotatably mounted in a scanning mirror frame portion;
a counterweight having a pair of springs thereon and being rotatably mounted in said counterweight frame portion, said counterweight frame and said scanning mirror frame being connected to position said rotatably scanning mirror and rotatably counterweight in a predetermined spaced relationship aligned for said rotatable scanning mirror to collide with one said rotatable counterweight spring in each direction of rotation to thereby repel and reverse the direction of rotation of said scanning mirror with each collision; and
at least one actuator for moving said counterweight in a back and forth direction of rotation for collision with said scanning mirror;
whereby a laser scanner scanning mirror scanning motion is produced by an oscillating counterweight colliding with a rotatably mounted scanning mirror.

15. The laser scanner apparatus in accordance with claim 16 in which each said counterweight spring is a coil spring.

16. The laser scanner apparatus in accordance with claim 15 in which each said coil spring has a cover thereover.

17. The laser scanner apparatus in accordance with claim 14 in which each said actuator is a voice coil actuator.

18. The laser scanner apparatus in accordance with claim 17 including a position encoder coupled to read the position of said counterweight.

19. The laser scanner apparatus in accordance with claim 18 including a position encoder coupled to read the position of said scanning mirror.

20. The laser scanner apparatus in accordance with claim 14 in which said scanning mirror has a bumper positioned for contact with each said counterweight spring during each collision between said scanning mirror and said counterweight.
